(19) United States
(12) Patent Application Publication
(10) Pub. No.: US 2024/0075799 A1
(43) Pub. Date: Mar. 7, 2024

(54) TRACTION BATTERY PACK SUPPORT SYSTEM AND METHOD OF SECURING A BATTERY PACK TO AN ELECTRIFIED VEHICLE

(71) Applicant: Ford Global Technologies, LLC, Dearborn, MI (US)

(72) Inventor: Patrick Daniel Maguire, Ann Arbor, MI (US)

(21) Appl. No.: 18/163,931

(22) Filed: Feb. 3, 2023

Related U.S. Application Data
(60) Provisional application No. 63/403,445, filed on Sep. 2, 2022.

(51) Int. Cl. B60K 1/04; B60L 50/60; B62D 25/02; H01M 50/204; H01M 50/244; H01M 50/249; H01M 50/264; H01M 50/271

(52) U.S. Cl. CPC B60K 1/04; B60L 50/60; B62D 25/025; H01M 50/204; H01M 50/244; H01M 50/249; H01M 50/264; H01M 50/271; B60K 2001/0438; B62D 65/02

(57) ABSTRACT

A battery pack support system includes a rocker assembly that has a body portion and a pack portion. The pack portion is secured to the body portion to connect a battery pack to a vehicle. The pack portion configured to compress a plurality of battery cells within the battery pack.

### CROSS-REFERENCE TO RELATED APPLICATIONS

This application claims priority to U.S. Provisional Application No. 63/403,445, which was filed on 2 Sep. 2022 and is incorporated herein by reference.

### TECHNICAL FIELD

This disclosure relates generally to a support system that secures a traction battery to a electrified vehicle.

### BACKGROUND

A traction battery pack of an electrified vehicle can include groups of battery cells arranged in one or more cell stacks. An enclosure houses the cell stacks. The traction battery pack can be secured to underbody of the electrified vehicle.

### SUMMARY

In some aspects, the techniques described herein relate to a battery pack support system, including: a rocker assembly having a body portion and a pack portion, the pack portion secured to the body portion to connect a battery pack to a vehicle, the pack portion configured to compress a plurality of battery cells within the battery pack.

In some aspects, the techniques described herein relate to a battery pack support system, wherein the pack portion is positioned vertically beneath the body portion.

In some aspects, the techniques described herein relate to a battery pack support system, further including a cover of the battery pack, the cover including a portion extending laterally outward from a centerline of the vehicle and captured between the pack portion and the body portion.

In some aspects, the techniques described herein relate to a battery pack support system, wherein the cover has a hat-shaped cross-section.

In some aspects, the techniques described herein relate to a battery pack support system, wherein the pack portion is at least partially received within the cover.

In some aspects, the techniques described herein relate to a battery pack support system, wherein the plurality of battery cells are at least partially received within the cover.

In some aspects, the techniques described herein relate to a battery pack support system, wherein the rocker assembly is a driver side rocker assembly, the body portion is a driver side body portion, and the pack portion is a driver side body portion, and further including a passenger side rocker assembly having a passenger side body portion and a passenger side pack portion.

In some aspects, the techniques described herein relate to a battery pack support system, further including a floor of the battery pack, the floor secured directly to the driver side body portion and the passenger side body portion.

In some aspects, the techniques described herein relate to a battery pack support system, further including a vehicle cross-member that spans from the driver side body portion to the passenger side body portion.

In some aspects, the techniques described herein relate to a battery pack support system, wherein the pack portion is stamped steel.

In some aspects, the techniques described herein relate to a battery pack support system, wherein a vertical height of the body portion is no more than twenty-five millimeters.

In some aspects, the techniques described herein relate to a battery pack support system, wherein an outboard side of the body portion and an outboard side of the pack portion are aligned.

In some aspects, the techniques described herein relate to a battery pack support system, wherein the pack portion is inboard the body portion.

In some aspects, the techniques described herein relate to a method of securing a battery pack to a vehicle, including: securing a pack portion of a rocker assembly to a body portion of the rocker assembly to connect a battery pack to a vehicle; and compressing a plurality of battery cells using the pack portion.

In some aspects, the techniques described herein relate to a method, further including sandwiching a portion of a cover of the battery pack between the pack portion and the body portion during the securing.

In some aspects, the techniques described herein relate to a method, wherein the pack portion is at least partially received within the cover after the securing.

In some aspects, the techniques described herein relate to a method, wherein the plurality of battery cells are at least partially received within the cover.

In some aspects, the techniques described herein relate to a method, wherein an outboard side of the pack portion is aligned with an outboard side of the body portion.

In some aspects, the techniques described herein relate to a method, wherein the pack portion is inboard the body portion.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 2 according to an exemplary embodiment of the present disclosure.

FIG. 3 illustrates a section view of the battery pack at line 3-3 in FIG. 2 moving to an installed position beneath an underbody of the vehicle of FIG. 1.

FIG. 4 illustrates the section view of the battery pack of FIG. 2 after moving to the installed position beneath the underbody of the vehicle of FIG. 1.

FIG. 5 illustrates a section view of a battery pack according to another exemplary embodiment of the present disclosure when the battery pack is moving to an installed position beneath an underbody of a vehicle.

FIG. 6 illustrates the section view of the battery pack of FIG. 5 after moving to the installed position beneath the underbody of the vehicle.

### DETAILED DESCRIPTION

This disclosure details exemplary installation systems for securing a battery pack to an underbody of an electrified vehicle.

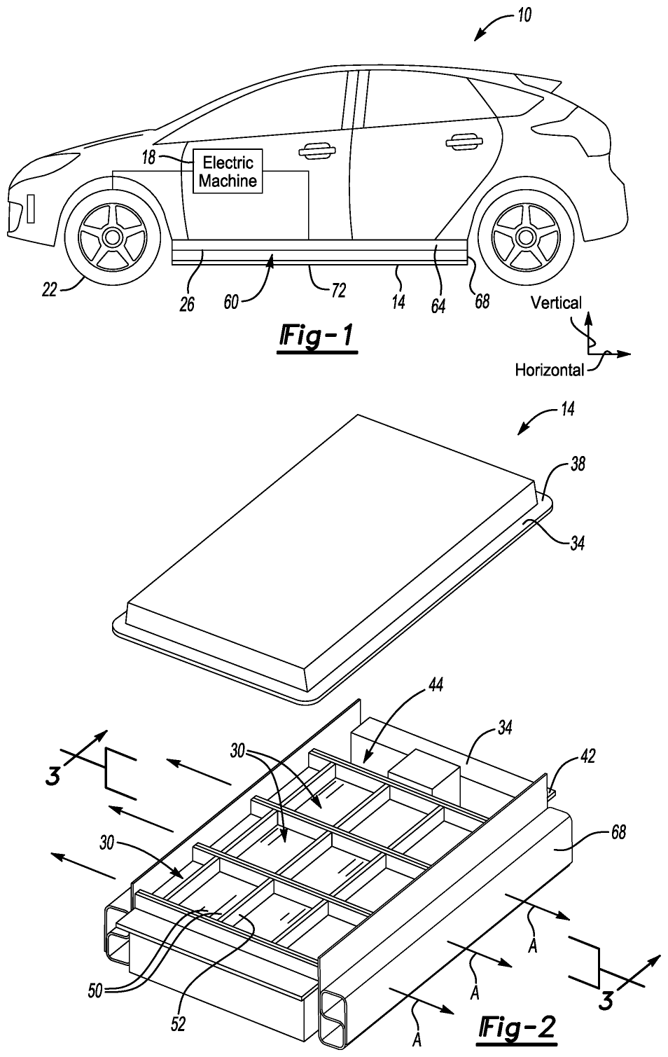

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

With reference now to FIGS. 2, the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes a plurality of battery cells 50 (or simply “cells”) and at least one divider 52 distributed along a respective cell stack axis A. The battery cells 50 are stacked side-by-side relative to each along the cell stack axis A. The battery cells 50 store and supply electrical power. Although a specific number of the cell stacks 30 and cells 50 are illustrated in the various figures of this disclosure, the battery pack 14 could include any number of the cell stacks 30 each having any number of individual cells 50.

In an embodiment, the battery cells 50 are lithium-ion pouch cells. However, battery cells having other geometries (cylindrical, prismatic, etc.), other chemistries (nickel metal hydride, lead acid, etc.), or both could be alternatively utilized within the scope of this disclosure. The exemplary battery cells 50 can include tab terminals extending from a battery cell housing. An aluminum film can provide the housing, for example.

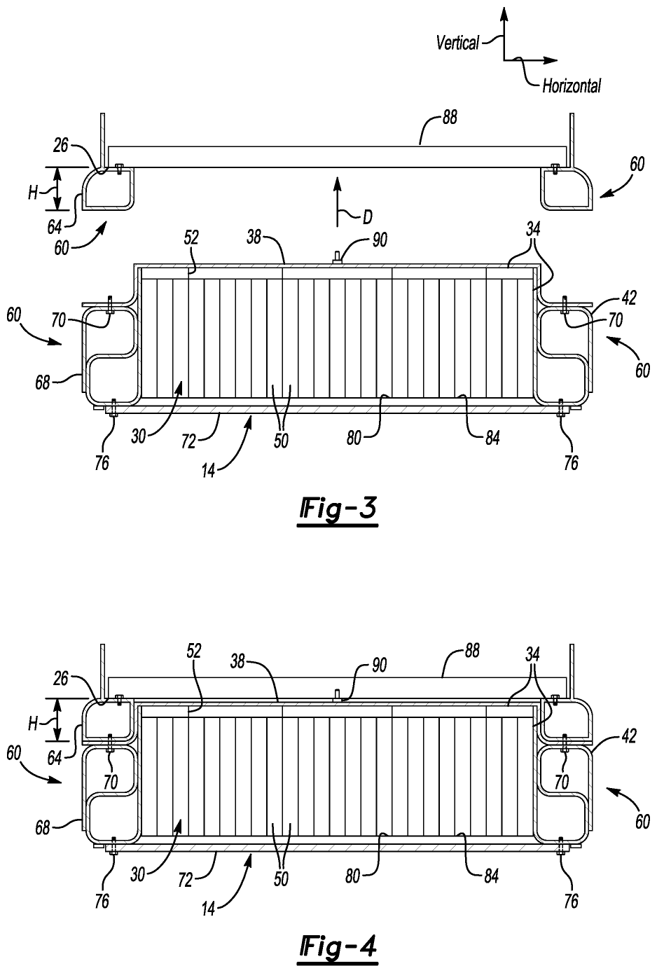

With reference now to FIGS. 3 and 4 and continued reference to FIGS. 1 and 2, installing the battery pack 14 to the vehicle 10 can involve moving the battery pack 14 vertically upward into an installed position beneath the vehicle 10. Vertical and horizonal, for purposes of this disclosure, are with reference to ground and an ordinary orientation of the vehicle 10 during operation.

While installing or “decking” the battery pack 14 to the vehicle 10, maintaining particular clearances between the battery pack 14 and structures of the vehicle 10 may be desired. The example battery pack 14 is secured to the vehicle 10 through a support system that facilitates maintaining these clearances.

In the exemplary embodiment, the support system includes a pair of rocker assemblies 60 each having multiple portions. In this example, the rocker assemblies 60 each include a body portion 64 and a pack portion 68. The body portions 64 are part of a frame of the vehicle 10 and are structural components of the vehicle 10. The body portions 64 are installed when the vehicle 10 is at the body-in-white (BIW) stage. The pack portions 68 are part of the battery pack 14. The pack portions 68 extend along opposing outboard sides of the battery pack 14. When the battery pack 14 is installed, outboard sides of the body portions 64 are aligned with respective outboard sides of the pack portions 68.

During installation, the battery pack 14 is moved in a direction D into the installed position for FIG. 4. The body portions 64 and the pack portions 68 are then secured together to connect the battery pack 14 to the vehicle 10. When installed, the pack portions 68 are positioned vertically beneath the body portions 64. Various mechanical fasteners 70 can be utilized to secure the body portions 64 to the pack portions 68.

The enclosure tray 42 is, in this example, an assembly that includes the pack portions 68 and a floor 72. A plurality of mechanical fasteners 76 secure the floor 72 directly to the pack portions 68. The cells stacks 30 rest on the floor 72. In some examples, a thermal exchange plate 80 and a layer of thermal interface material 84 could be sandwiched vertically between the cell stacks 30 and the floor 72, or the floor 72 could be the same the thermal exchange plate 80.

The enclosure cover 38 has a hat-shaped cross-section in the example battery pack 14. When the battery pack 14 is installed, a portion of the battery pack 14 is received horizontally between the body portion 64. Some of the enclosure cover 38 is captured vertically between the body portion 64 and the pack portions 68. The portions of the enclosure cover 38 that are captured vertically between the body portion 64 and the pack portions 68 extend laterally outward from a centerline of the vehicle 10 and generally correspond to a “rim” of the hat-shaped cross section.

The pack portions 68 are partially received vertically within the enclosure cover 38. Portions of the battery cells 50 may also be at least partially received within the enclosure cover 38. The pack portions 68 compress the battery cells 50 along the axes A of the cell stacks 30. In this example, the pack portions 68 are stamped steel, but other materials could be used, including metal and non-metal materials.

Within the vehicle 10, at least one vehicle cross-member 88 spans from the body portion 64 on the driver side to the body portion 64 on the passenger side. In addition to being secured to the vehicle 10 via the attachment of the body portions 64 to the pack portions 68, the example battery pack 14 is attached to the at least one vehicle cross-member 88 through at least one mechanical fastener 90.

A height H of the example body portion 64 is no more than twenty-five millimeters. This can facilitate maintaining desired clearances as the battery pack 14 is moved to the installed position. The rocker assembly 60 having both the body portion 64 and the pack portion 68 provides design flexibility and also facilitates maintaining the desired clearances.

In an example, nineteen millimeters of clearance between the battery pack 14 and the vehicle 10 in horizontal directions may be needed until the battery pack 14 is vertically within twenty-five millimeters of an installed position. This can permit locator/alignment pins to engage and align the battery pack 14 relative to the vehicle 10 as the battery pack 14 is secured to the vehicle 10. The locator/alignment pins could be 35 millimeters long, for example. Further, the locator/alignment pins could include a tapered top such that the locator/alignment pins are engaged and controlling a position of the battery pack 14 relative to the vehicle 10 after 25 millimeters of the locator/alignment pin engagement. Longer locator/alignment pins, such as 100 millimeter long engagement pins, may be more difficult to maintain and keep tolerances than shorter locator/alignment pins. Once the battery pack 14 is vertically within twenty-five millimeters of the installed position, the desired clearance between the battery pack 14 and the vehicle 10 in horizonal directions may reduce from nineteen millimeters to six millimeters. The body portions 64 being about twenty five millimeters tall can facilitate maintaining these clearances during installation.

An method of securing the battery pack 14 to the vehicle 10 includes securing the pack portions 68 to the body portions 64 to connect the battery pack 14 to vehicle 10. The pack portions 68 compress the cells 50 of the cell stacks 30. In an example, the method includes sandwiching a portion of the enclosure cover 38 between the body portions 64 and the pack portions 68 during the securing.

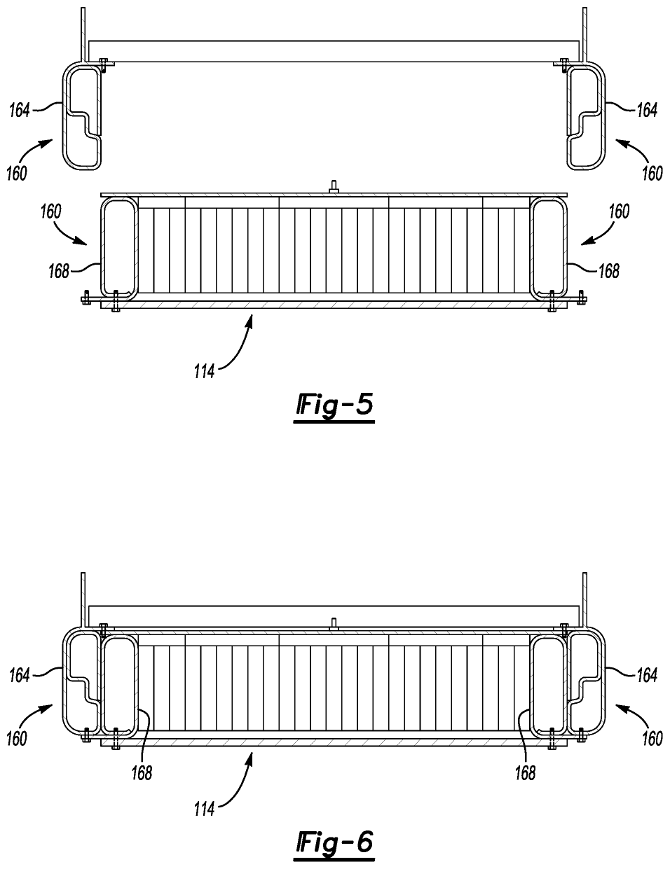

With reference to FIGS. 5 and 6, in another example, rocker assemblies 160 can be used to help maintain desired clearances. The rocker assembles 160, like the rocker assemblies 60, each include a body portion 164 and a pack portion 168. The body portions 164 are part of a frame of a vehicle and are structural components of the vehicle. The body portions 164 can be installed when the vehicle is at the body-in-white (BIW) stage. The pack portions 168 are part of the battery pack 14. The pack portions 68 extend along opposing outboard sides of a battery pack 114. When the battery pack 114 is installed, the pack portions 168 are inboard the body portions 164. The pack portions 168 are secured directly to the body portions 164. The pack portions 168 compress battery cells of the batter pack 113.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack support system, comprising:
a rocker assembly having a body portion and a pack portion, the pack portion secured to the body portion to connect a battery pack to a vehicle, the pack portion configured to compress a plurality of battery cells within the battery pack.

2. The battery pack support system of claim 1, wherein the pack portion is positioned vertically beneath the body portion.

3. The battery pack support system of claim 1, further comprising a cover of the battery pack, the cover including a portion extending laterally outward from a centerline of the vehicle and captured between the pack portion and the body portion.

4. The battery pack support system of claim 3, wherein the cover has a hat-shaped cross-section.

5. The battery pack support system of claim 3, wherein the pack portion is at least partially received within the cover.

6. The battery pack support system of claim 3, wherein the plurality of battery cells are at least partially received within the cover.

7. The battery pack support system of claim 1, wherein the rocker assembly is a driver side rocker assembly, the body portion is a driver side body portion, and the pack portion is a driver side body portion, and further comprising a passenger side rocker assembly having a passenger side body portion and a passenger side pack portion.

8. The battery pack support system of claim 7, further comprising a floor of the battery pack, the floor secured directly to the driver side body portion and the passenger side body portion.

9. The battery pack support system of claim 7, further comprising a vehicle cross-member that spans from the driver side body portion to the passenger side body portion.

10. The battery pack support system of claim 1, wherein the pack portion is stamped steel.

11. The battery pack support system of claim 1, wherein a vertical height of the body portion is no more than twenty-five millimeters.

12. The battery pack support system of claim 1, wherein an outboard side of the body portion and an outboard side of the pack portion are aligned.

13. The battery pack support system of claim 1, wherein the pack portion is inboard the body portion.

14. A method of securing a battery pack to a vehicle, comprising:
securing a pack portion of a rocker assembly to a body portion of the rocker assembly to connect a battery pack to a vehicle; and
compressing a plurality of battery cells using the pack portion.

15. The method of claim 14, further comprising sandwiching a portion of a cover of the battery pack between the pack portion and the body portion during the securing.

16. The method of claim 15, wherein the pack portion is at least partially received within the cover after the securing.

17. The method of claim 15, wherein the plurality of battery cells are at least partially received within the cover.

18. The method of claim 14, wherein an outboard side of the pack portion is aligned with an outboard side of the body portion.

19. The method of claim 18, wherein the pack portion is inboard the body portion.
